(19) United States
(12) Patent Application Publication
(10) Pub. No.: US 2023/0306458 A1
(43) Pub. Date: Sep. 28, 2023

(54) DATA PROCESSING DEVICE AND PROGRAM FOR RETAIL STAMP CARD SERVICE

(71) Applicant: Toshiba Tec Kabushiki Kaisha, Tokyo (JP)

(72) Inventors: Kento YAMADA, Numazu Shizuoka (JP); Takuji SAKAGUCHI, Katsushika Tokyo (JP)

(21) Appl. No.: 18/172,162

(22) Filed: Feb. 21, 2023

(30) Foreign Application Priority Data
Mar. 28, 2022 (JP) 2022-051730

(51) Int. Cl. G06Q 30/0226; G06Q 30/0207

(52) U.S. Cl. CPC G06Q 30/0229; G06Q 30/0236

(57) ABSTRACT

According to one embodiment, a server device for a retail stamp card service includes a communication interface connectable to a network and a storage unit for storing electronic stamp cards for a plurality of purchasers and stamp issuance conditions for a plurality of stores. A processor of the server device is configured to acquire purchaser identification information and receipt data indicating details of a purchase by a purchaser at a store and determine, based on the receipt data, whether a stamp issuance condition has been satisfied. The processor then issues stamp data if the stamp issuance condition has been satisfied and updates stamp card data according to the issued stamp data. The stamp issuance conditions can be set on an individual store basis, a brand basis, or an operating company basis based on operator input to the server device.

### CROSS-REFERENCE TO RELATED APPLICATION

This application is based upon and claims the benefit of priority from Japanese Patent Application No. 2022-051730, filed Mar. 28, 2022, the entire contents of which are incorporated herein by reference.

### FIELD

Embodiments described herein relate generally to a data processing device and a computer program for stamp card services at retail stores and the like.

### BACKGROUND

There are stores that implement a stamp card service for the purpose of sales promotion and the like. With such a stamp card service, a purchaser presents a stamp card to the store at checkout time to receive a stamping or stamp. The store grants a privilege to the purchaser (customer) once the number of stamps reach some predetermined total number. A service that uses an electronic stamp card instead of a stamp card of a paper type has been previously proposed.

For a company that operates multiple stores of the same type (e.g. a chain store) or of different types (e.g., related but independent brand stores), it may be difficult to coordinate conditions for granting transaction stamps and the stamps applied at different stores of the same company may have different appearances at each of the different stores, making it difficult to determine if the privilege associated with meeting the total number of transaction should be granted.

It is not easy to set appropriate stamping conditions amongst different stores and existing art lacks flexibility with regard to the setting of stamping conditions and the like.

### BRIEF DESCRIPTION OF THE DRAWINGS

FIG. 1 is a diagram illustrating an example of a configuration of a system according to an embodiment.

FIG. 2 is a diagram illustrating an example of a hardware configuration of an information terminal according to an embodiment.

FIG. 3 is a diagram illustrating an example of a screen displayed on a display unit of an information terminal.

FIG. 4 is a diagram illustrating an example of a hardware configuration of a POS terminal according to an embodiment.

FIG. 5 is a diagram illustrating an example of a data structure of electronic receipt data generated by a POS terminal.

FIG. 6 is a diagram illustrating an example of a hardware configuration of a center server according to an embodiment.

FIG. 7 is a diagram illustrating an example of a data structure of a store record according to an embodiment.

FIG. 8 is a diagram illustrating an example of a data structure of a card setting record according to an embodiment.

FIG. 9 is a diagram illustrating an example of a data structure of a promotion record according to an embodiment.

FIG. 10 is a diagram illustrating an example of a data structure of a receipt record according to an embodiment.

FIG. 11 is a diagram illustrating an example of a data structure of a card record according to an embodiment.

FIG. 12 is a diagram depicting certain functional aspects of a center server.

FIG. 13 is a diagram illustrating an example of a setting screen displayed by a setting managing unit according to an embodiment.

FIG. 14 is a diagram illustrating an example of a target setting file according to an embodiment.

FIG. 15 is a diagram illustrating an example of a receipt image displayed on a display unit of an information terminal.

FIG. 16 is a diagram illustrating an example of an electronic stamp card image displayed on a display unit.

FIG. 17 is a diagram illustrating an example of a stamp history image displayed on a display unit.

FIG. 18 is a flowchart of a stamp service setting processing performed by a center server.

FIG. 19 is a flowchart of acquisition processing for electronic receipt data performed by a center server.

FIG. 20 is a flowchart illustrating an example of browsing processing performed by a center server.

FIG. 21 is a flowchart illustrating an example of browsing processing performed by a center server.

### DETAILED DESCRIPTION

Certain example embodiments provide a data processing device and a software program providing a stamp card service more flexibly than existing art across multiple stores, including stores of different types.

In general, according to one embodiment, a server device for a retail stamp card service includes a communication interface connectable to a network and a storage unit for storing electronic stamp cards for a plurality of purchasers and stamp issuance conditions for a plurality of stores. A processor of the server device is configured to: acquire purchaser identification information and receipt data indicating details of a purchase by a purchaser at a store; determine, based on the receipt data, whether a stamp issuance condition has been satisfied; issue stamp data if the stamp issuance condition has been satisfied; update stamp card data associated with the purchaser identification information according to the issued stamp data; and set stamp issuance conditions for stores in the plurality of stores on an individual store basis, a brand basis, and an operating company basis based on operator input to the server device.

An example embodiment is explained below with reference to the drawings. The present disclosure is not limited to the example embodiment. In the following explanation, an electronic stamp card system introduced into an electronic receipt system is explained as one example.

In this context, an electronic receipt system is a system that converts information for a receipt issued from a POS terminal of a store into electronic receipt data and stores the electronic receipt data on an electronic receipt server (referred to as a center server). The electronic receipt service enables a purchaser to browse electronic receipt data stored on the center server for the purchaser using an information terminal such as a smartphone. The electronic stamp card system stores, on the center server, an electronic stamp card to which stamps are electronically granted for every checkout at a store. The purchaser can then browse information related to the electronic stamp card(s) stored on the center server using the information terminal such as a smartphone. The electronic stamp card with a predetermined number of stamps can be exchanged for a privilege such as a gift certificate or transaction discount.

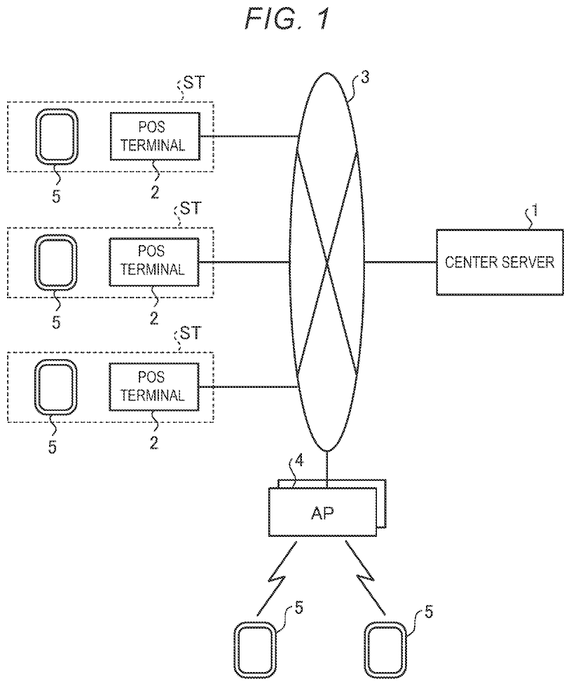

FIG. 1 is a diagram illustrating an example of a configuration of a system according to this embodiment. The system includes a center server 1, POS terminals 2 in different stores ST, and a network 3 such as the Internet.

The center server 1 is an example of the data processing device or a server device. The center server 1 functions as a data processing device for coordinating the electronic receipt system and the electronic stamp card system. The POS terminals 2 have a function of generating electronic receipt data and transmitting the electronic receipt data to the center server 1. The network 3 connects the server 1 and the POS terminals 2. The center server 1 and the POS terminals 2 perform data communication via the network 3.

The system uses information terminals 5 such as smartphones carried by purchasers (consumers or members). The information terminals 5 can perform wireless communication using a technique of a wireless LAN (Local Area Network) or mobile communication. A plurality of access points 4 capable of performing wireless communication with the information terminals 5 are connected to the network 3. The access points 4 are disposed to be scattered in places such that wireless communication regions thereof do not generally overlap. The information terminal 5 present in the wireless communication region of any one of the access points 4 is capable of performing wireless communication with the access point 4. With the wireless communication, the information terminal 5 transmits a request to the center server 1 and displays, on a display device, an image provided from the center server 1.

In this embodiment, an example is explained in which the center server 1 is realized by a single server device. However, in other examples, the center server 1 may be realized by a plurality of server devices according to a technique such as Cloud computing.

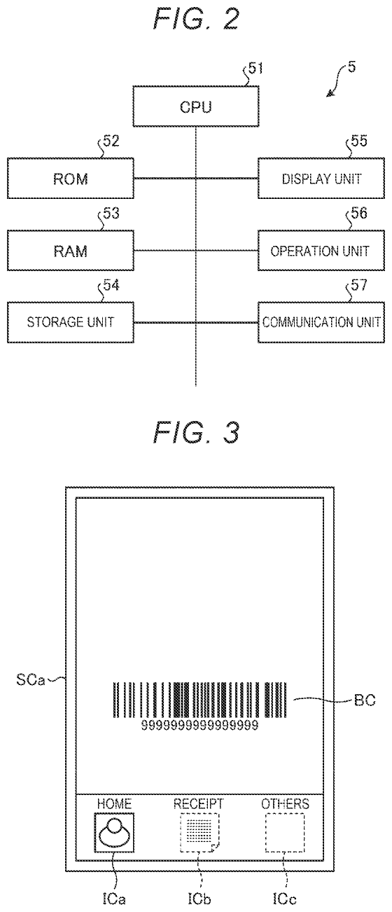

FIG. 2 is a diagram illustrating an example of a hardware configuration of the information terminal 5. As illustrated in FIG. 2, the information terminal 5 includes computer components such as a CPU (Central Processing unit) 51, a ROM (Read Only Memory) 52, and a RAM (Random Access Memory) 53.

The CPU 51 is an example of a processor and collectively controls the units of the information terminal 5. The ROM 52 stores various programs. The RAM 53 is a work space in which programs and various data are loaded.

The information terminal 5 includes a storage unit 54, a display unit 55, an operation unit 56, and a communication unit 57.

The storage unit 54 is configured by a storage medium such as an HDD (Hard Disk Drive) or a flash memory and maintains stored content even if the information terminal 5 is turned off. The storage unit 54 stores programs executable by the CPU 51 and various kinds of setting information. The storage unit 54 functions as a storage region for storing various data transmitted from an external device such as the center server 1 and a storage region for storing a processing result.

The display unit 55 is configured by a display device such as an LCD (Liquid Crystal Display). The display unit 55 displays various kinds of information under control of the CPU 51. The operation unit 56 includes a keyboard and a pointing device. The operation unit 56 outputs operation content received from an operator to the CPU 51. The operation unit 56 may be a touch panel provided on a display screen of the display unit 55.

The communication unit 57 is a communication interface connectable to the network 3. The communication unit 57 performs communication with an external device such as the center server 1 via the network 3.

An application program exclusive for members (hereinafter referred to as member program) for using the electronic receipt system and the electronic stamp card system in cooperation is downloaded to the information terminal 5 having such a configuration. The member program is stored in, for example, the storage unit 54. A purchaser, who is a user of the information terminal 5, can perform member registration by downloading the member program to the information terminal 5. If the member registration is performed, a unique member ID common to the electronic receipt system and the electronic stamp card system is issued as purchaser specifying information for specifying the purchaser. Data of the member ID is also stored in, for example, the storage unit 54.

If the member program is started, for example, a screen SCa having a layout illustrated in FIG. 3 is displayed on the display unit 55. FIG. 3 is a diagram illustrating an example of the screen SCa displayed on the display unit 55 of the information terminal 5.

As illustrated in FIG. 3, a barcode BC is displayed on the screen SCa. The barcode BC is the member ID converted into a barcode. If the member program is started, a home icon ICa, a receipt icon ICb, and an others icon ICc are displayed on the display unit 55. The home icon ICa changes to a selected state and the receipt icon ICb and the others icon ICc change to an unselected state.

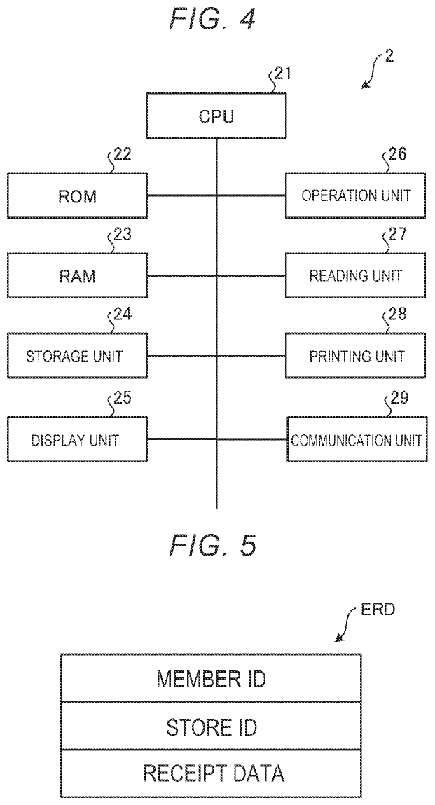

FIG. 4 is a diagram illustrating an example of a hardware configuration of the POS terminal 2. As illustrated in FIG. 4, the POS terminal 2 includes computer components such as a CPU 21, a ROM 22, and a RAM 23.

The CPU 21 is an example of a processor and collectively controls the units of the POS terminal 2. The ROM 22 stores various programs. The RAM 23 is a work space in which programs and various data are loaded.

The POS terminal 2 includes a storage unit 24, a display unit 25, an operation unit 26, a reading unit 27, a printing unit 28, and a communication unit 29.

The storage unit 24 is configured by a storage medium such as an HDD or a flash memory and maintains stored content even if the POS terminal 2 is turned off. The storage unit 24 stores programs executable by the CPU 21 and various kinds of setting information. The storage unit 24 functions as a storage region for storing various data transmitted from an external device such as the center server 1 and a storage region for storing a processing result.

The display unit 25 is configured by a display device such as an LCD. The display unit 25 displays various kinds of information under control of the CPU 21. The operation unit 26 includes a keyboard and a pointing device. The operation unit 26 outputs operation content received from an operator to the CPU 21. The operation unit 26 may be a touch panel provided on a display screen of the display unit 25.

The reading unit 27 reads a barcode, a two-dimensional code, or the like attached to a commodity. The reading unit 27 reads the barcode BC of the member ID displayed on the display unit 55 of the display terminal 5. As the reading unit 27, a well-known device such as a barcode scanner or a two-dimensional scanner can be applied alone or in combination.

The printing unit 28 is a printing device such as a thermal printer. The printing unit 28 prints a receipt image on receipt paper and dispenses a receipt under control of the CPU 21.

The communication unit 29 is a communication interface connectable to the network 3. The communication unit 29 performs communication with an external device such as the center server 1 via the network 3.

A configuration of the POS terminal 2 is not limited to the example explained above. For example, the POS terminal 2 may include an automatic change machine. The automatic change machine includes bill and coin deposit ports and calculates an amount of deposited bills or coins. The automatic change machine calculates, as a change amount, a difference amount obtained by deducting a transaction amount from the deposited amount and dispenses bills or coins equivalent to the change amount to a dispensing port.

The POS terminal 2 having such a configuration is set in, for example, a checkout corner of a store ST. The number of POS terminals 2 set in one store ST is not limited to one. Typically, a plurality of POS terminals 2 are set in one store ST. However, in this embodiment, for convenience, the explanation is continued assuming that one POS terminal 2 is set in one store.

If data of a commodity to be purchased by the purchaser is input via the operation unit 26 or the reading unit 27, the CPU 21 of the POS terminal 2 performs sales processing for sales data of the commodity. If operation for instructing to end the data input of the purchase commodity is performed via the operation unit 26, the CPU 21 causes the display unit 25 to display a transaction amount calculated based on a price of the purchase commodity. Thereafter, if an amount equal to or more than the transaction amount is deposited via the automatic change machine or the like, the CPU 21 generates receipt data.

The receipt data indicates details of purchase and includes a name, a unit price, the number of articles, an amount, a transaction amount, a deposit amount, and a change amount of the purchase commodity. The receipt data includes a transaction date and time and a receipt ID. The transaction date and time is, for example, date and time information indicating a date and time of a point in time when the receipt data is generated. The transaction date and time may be, for example, a date and time of a point in time when data of a first item of a commodity to be purchased by the purchaser is input. The receipt ID is a unique code issued every time receipt data is generated. The receipt ID is counted up every time receipt data is generated, for example, after the transaction date and time. A value of a counter that is reset if a date is updated is added to the receipt ID.

If finishing generating the receipt data, the CPU 21 determines whether to perform electronic receipt processing. Specifically, if the barcode BC on the screen SCa displayed on the display unit 55 of the information terminal 5 carried by the purchaser is read via the reading unit 27, the CPU 21 determines to perform the electronic receipt processing. If the barcode BC is not read, the CPU 21 determines not to perform the electronic receipt processing. If the electronic receipt processing is not performed, the CPU 21 controls the printing unit 28 to control issuance of a receipt on which the receipt data is printed. If determining to perform the electronic receipt processing, the CPU 21 generates electronic receipt data obtained by adding a member ID and a store ID to the receipt data as illustrated in FIG. 5.

FIG. 5 is a diagram illustrating an example of a data structure of the electronic receipt data generated by the POS terminal 2. As illustrated in FIG. 5, electronic receipt data ERD includes the member ID, the store ID, and the receipt data.

The member ID is a code obtained by analyzing the barcode BC. The store ID is an ID specified to the store set in advance and is stored in, for example, the storage unit 24. The CPU 21 transmits the electronic receipt data ERD to the center server 1 via the communication unit 29.

As the POS terminal 2 that performs such an operation, a POS terminal adapted to an existing electronic receipt system can be directly applied.

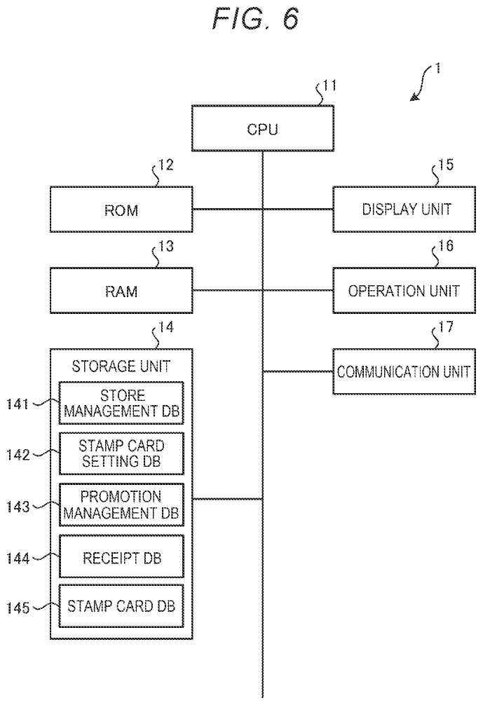

FIG. 6 is a diagram illustrating an example of a hardware configuration of the center server 1. As illustrated in FIG. 6, the center server 1 includes computer components such as a CPU 11, a ROM 12, and a RAM 13.

The CPU 11 is an example of a processor and collectively controls the units of the center server 1. The ROM 12 stores various programs. The RAM 13 is a work space in which programs and various data are loaded.

The center server 1 includes a storage unit 14, a display unit 15, an operation unit 16, and a communication unit 17.

The storage unit 14 is configured by a storage medium such as an HDD or a flash memory and maintains stored content even if the center server 1 is turned off. The storage unit 14 stores programs executable by the CPU 11 and various kinds of setting information. The storage unit 14 functions as a storage region for storing various data transmitted from external devices such as the POS terminals 2 and the network 3 and a storage region for storing a processing result.

The storage unit 14 stores a store management DB (database) 141, a stamp card setting DB 142, a promotion management DB 143, a receipt DB 144, and a stamp card DB 145.

The store management DB 141 is a region for storing a record for managing information concerning each of stores ST (hereinafter referred to as store record 1411).

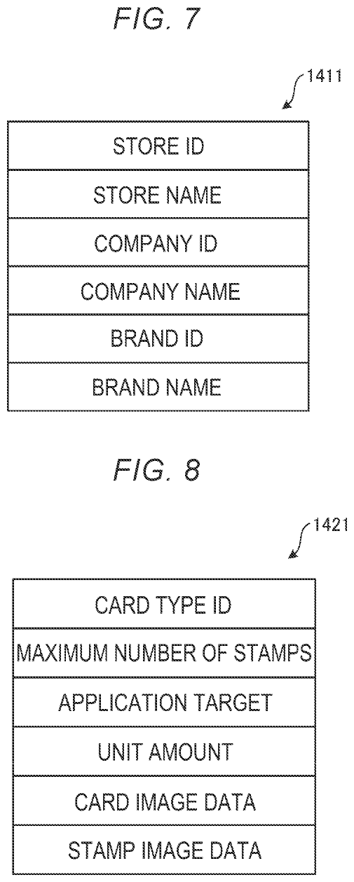

FIG. 7 is a diagram illustrating an example of a data structure of the store record 1411. As illustrated in FIG. 7, the store record 1411 includes a store ID, a store name, a company ID, a company name, a brand ID, and a brand name. The store record 1411 may include items other than the above.

The store ID is information for identifying each of the stores ST. The store name is a name of the store ST identified by the store ID. The company ID is information for identifying a company that operates the store ST. The company name is a name of the company identified by the company ID. The brand ID is information for identifying a brand to which the store ST identified by the store ID belongs. The brand name is a name of the brand identified by the brand ID.

The meaning of “brand” in this context is explained. Even if an operating company is the same, there can be stores ST for which business forms are different, for example, traded commodities are different. Depending on a company, the company may cover a wide range of businesses. For example, the company may operate several independent stores ST such as specialty stores under different names (brands) and/or a plurality of chain stores under the same name (brand). Thus, a store ST group having a common business form sometimes uses a common brand such as a trade name for each store ST in the group. A company A, which is an operating company managing multiple store, may have a chain of stores (a store group) operating under a trade name “XX” and also a chain of stores (a store group) operating under a trade name “YY”. Thus, in this context, “XX” and “YY” are respectively different brands, though owned/managed by the same company A.

The store name is preferably a name capable of identifying each of stores under the same brand by using, for example, a location and a number. In some examples, a store ST not belonging to any other brand may be present. In this case, the brand ID and the brand name of the store record 1411 can be blank. In this example, the same store ST does not belong to multiple brands.

The stamp card setting DB 142 is a region for storing a record relating to setting of an electronic stamp card (hereinafter referred to as card setting record 1421). The electronic stamp card is a stamp card converted into an electronic form and is a medium capable of collecting a stamp also converted into an electronic form.

FIG. 8 is a diagram illustrating an example of a data structure of the card setting record 1421. As illustrated in FIG. 8, the card setting record 1421 includes a card type ID, a maximum number of stamps, an application target, a unit amount, card image data, and stamp image data. The card setting record 1421 may include items other than the above.

The card type ID is information for specifying a type of an electronic stamp card. The electronic stamp card is issued in, for example, a store unit of the store ST, a brand unit, or a company unit. The maximum number of stamps is a maximum number of stamps collectable by one electronic stamp card. If the electronic stamp card is regarded as a paper stamp card, the one electronic stamp card corresponds to one paper stamp card. An integer of a quotient obtained by dividing the number of actually collected stamps by the maximum number of stamps is the number of paper stamp cards.

The application target is information for specifying stores or a range of stores that use the electronic stamp card of the card type ID. In the application target, any one of a store ID, a brand ID, and a company ID can be set. For example, if the store ID is set in the application target, the electronic stamp card of the card type ID is used in a store of the set store ID. For example, if the brand ID is set in the application target, the electronic stamp card of the card type ID is used in all stores belonging to a brand of the brand ID. If the company ID is set in the application target, the electronic stamp card of the card type ID is used in all stores belonging to a company of the company ID.

The unit amount is an amount necessary for granting one stamp. Specifically, an integer of a quotient obtained by dividing a transaction amount by the unit amount is the number of granted stamps.

The card image data is image data of an electronic receipt card. The stamp data is image data of a stamp granted to the electronic receipt card.

The promotion management DB 143 is a region for storing a record for managing information relating to a promotion such as a sales promotion (hereinafter, promotion record 1431).

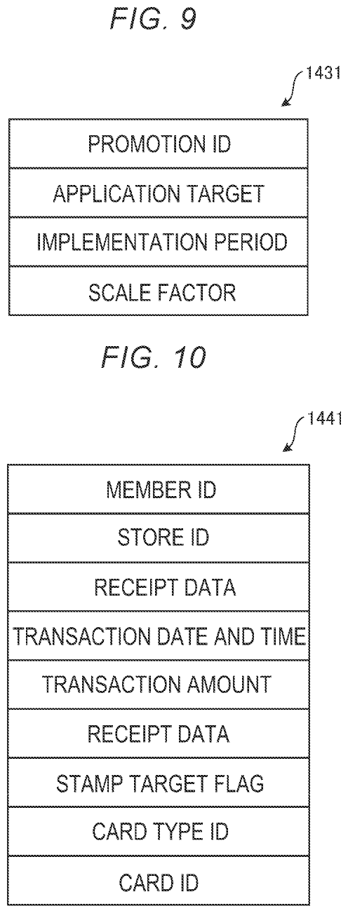

FIG. 9 is a diagram illustrating an example of a data structure of the promotion record 1431. As illustrated in FIG. 9, the promotion record 1431 includes a promotion ID, an application target, an implementation period, and a scale factor. The promotion record 1431 may include items other than the above.

The promotion ID is information for identifying each of promotions. The application target is information for specifying stores or a range of stores set as a target of the promotion. In the application target, as in the application target of the card setting record 1421, any one of a store ID, a brand ID, and a company ID can be set.

The implementation period is a period in which the promotion is implemented. The scale factor is a scale factor for granting a stamp. For example, if the scale factor is set to 2, whereas one stamp is usually granted if the reference amount is satisfied, two stamps are granted in the promotion period.

The receipt DB 144 is a region for storing a record including electronic receipt data received from each of the POS terminals 2 via the network 3 (hereinafter referred to as receipt record 1441).

FIG. 10 is a diagram illustrating an example of a data structure of the receipt record 1441. As illustrated in FIG. 10, the receipt record 1441 includes a member ID, a store ID, a receipt ID, a transaction date and time, a transaction amount, receipt data, a stamp target flag, a card type ID, and a card ID. The receipt record 1441 may include items other than the above.

The member ID, the store ID, and the receipt data are included in the electronic receipt data. The receipt ID, the transaction date and time, and the transaction amount are extracted from the receipt data.

The stamp target flag is one-bit information for identifying whether the receipt data identified by the receipt ID satisfies a stamping condition, according to a collected number of which a privilege is obtained. The stamping condition is explained below. For example, the stamp target flag is “1” if the stamping condition is satisfied and is “0” if the stamping condition is not satisfied.

The card type ID and the card ID are information for specifying an electronic receipt card for collecting the stamps. The receipt DB 144 functions as a storage unit that stores the purchaser specifying information (the member ID) and the receipt data in correlation with each other.

The stamp card DB 145 is a region for storing a record for managing an electronic stamp card issued to a purchaser and stamps collected by the electronic stamp card (hereinafter referred to as card record 1451).

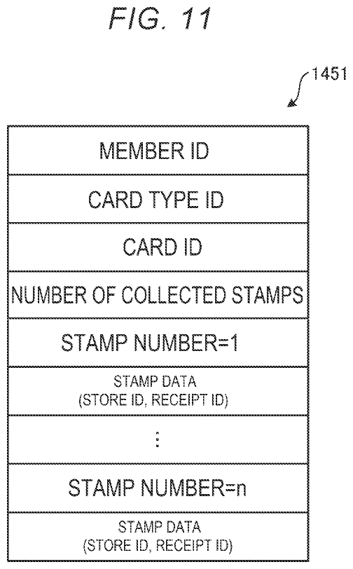

FIG. 11 is a diagram illustrating an example of a data structure of the card record 1451. As illustrated in FIG. 11, the card record 1451 includes a member ID, a card type ID, a card ID, the number of collected stamps, a stamp number, and stamp data. The card record 1451 may include items other than the above.

The member ID corresponds to the member ID explained above and identifies a purchaser, who is an owner of the electronic stamp card. The card type ID is information indicating a card type of the electronic stamp card issued to the purchaser of the member ID. The card ID is a unique code issued for each of electronic stamp cards in order to identify each of electronic stamp cards in the same card type. If the same purchaser owns electronic stamp cards of a plurality of card types, the card type ID and the card ID are stored for each of the card types in correlation with one member ID.

The card record 1451 includes, for each set of the card type ID and the card ID, the number of collected stamps, a number area in which the stamp number is set, and a storage area for storing stamp data associated with stamp numbers.

The number of collected stamps is the number of stamps collected by the electronic stamp card identified by the card type ID and the card ID. Number areas in which stamp numbers are respectively set are description areas for the collected stamps. Storage areas respectively corresponding to the number areas are areas for storing stamp data of the stamps described in the number areas corresponding to the storage areas. The stamp data stores the store ID and the receipt ID included in the receipt data to which the stamps described in the number areas corresponding to the stamp data are issued.

In this embodiment, the number of stamps collected by the electronic stamp card does not particularly matter. For example, the maximum number of stamps explained above may be set as an upper limit and, every time the number of stamps reaches the upper limit, an electronic stamp card of the same card type ID and the same card ID may be issued anew.

Specifically, if the number of collected stamps reaches the maximum number of stamps, a new electronic stamp card is issued to a purchaser who acquires the stamps. At that time, the card record 1451 only has to include items such as the number of cards and make it possible to identify which electronic stamp card the electronic stamp card is using the number of cards. For example, the number of cards is “1” for a first electronic receipt card and is “2” for a second electronic receipt card.

Referring back to FIG. 6, the display unit 15 is configured by a display device such as an LCD. The display unit 15 displays various kinds of information under control of the CPU 11. The operation unit 16 includes a keyboard and a pointing device. The operation unit 16 outputs operation content received from an operator to the CPU 11. The operation unit 16 may be a touch panel provided on a display screen of the display unit 15.

The communication unit 17 is a communication interface connectable to the network 3. The communication unit 17 performs communication with external devices such as the POS terminals 2 and the information terminals 5 via the network 3.

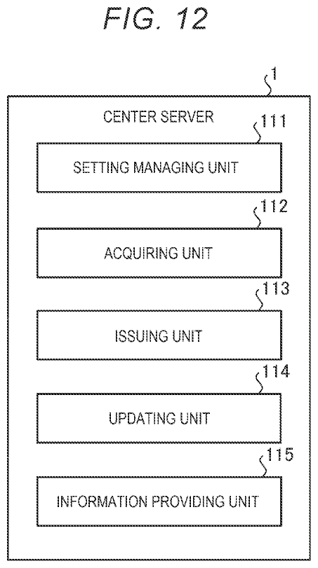

FIG. 12 is a diagram illustrating an example of a functional configuration of the center server 1. As illustrated in FIG. 12, the center server 1 includes a setting managing unit 111, an acquiring unit 112, an issuing unit 113, an updating unit 114, and an information providing unit 115 as functional components.

A part or all of the functional components included in the center server 1 may be software components realized by cooperation of a processor (for example, the CPU 51) of the center server 1 and programs stored in a memory (for example, the ROM 52 and the storage unit 54) of the center server 1. A part or all of the functional components included in the center server 1 may be hardware components realized by dedicated circuits or the like mounted on the center server 1.

The setting managing unit 111 is an example of a setting unit. The setting managing unit 111 manages various kinds of setting relating to a stamp service (hereinafter referred to as stamp setting). For example, upon receiving a command for requesting the stamp setting (hereinafter referred to as stamp setting request command) from the operation unit 16 or an external device, the setting managing unit 111 causes a display device of the requesting device to display a setting screen for performing the stamp setting.

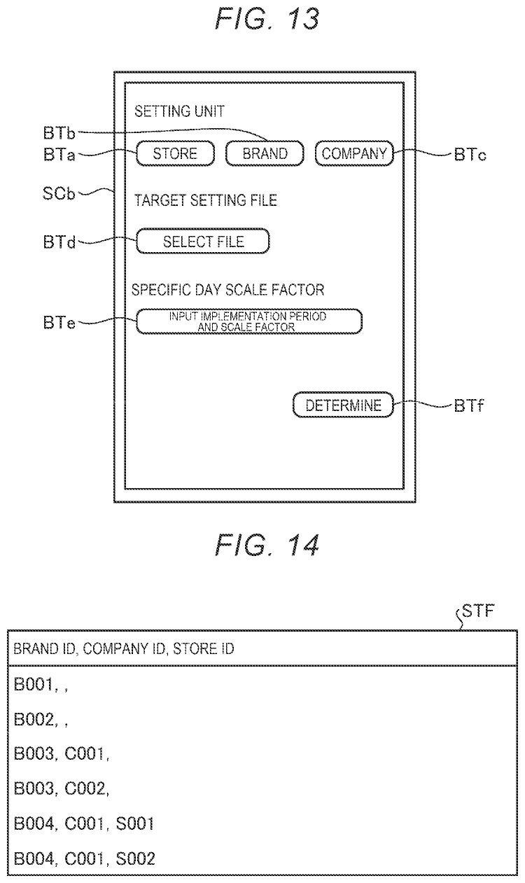

FIG. 13 is a diagram illustrating an example of a setting screen SCb displayed by the setting managing unit 111. Such a setting screen SCb is used, for example, if a scale factor for granting stamps relating to the store ST set as the application target of the promotion is changed.

On the setting screen SCb, the store ST set as a stamping target, that is, a target of the promotion, can be set using any one setting unit among a store unit for individually designating the store ST, a brand unit indicating a store group to which a business form is common, and a company unit indicating a store group to which an operating company is common. Specifically, the setting screen SCb includes selection buttons BTa, BTb, and BTc capable of selecting the store ST set as the stamping target in the store unit, the brand unit, and the company unit.

The selection button BTa is an operation piece capable of selecting a stamping target in a unit of the store ST. The selection button BTb is an operation piece capable of selecting a stamping target in a unit of a brand. The selection button BTc is an operation piece capable of selecting a stamping target in a unit of a company.

Upon operation of the selection button BTa, the setting managing unit 111 sets a stamping target on a per store ST basis. For example, the setting managing unit 111 displays a screen on which stores IDs or store names registered in the store management DB 141 are displayed as a list. The setting managing unit 111 sets, as a stamping target, a store ID of a store selected from the list.

Upon operation of the selection button BTb, the setting managing unit 111 sets a stamping target on a per brand basis. For example, the setting managing unit 111 displays a screen on which brand IDs or brand names registered in the store management DB 141 are displayed as a list. The setting managing unit 111 sets, as a stamping target, a brand ID of a brand selected from the list.

Upon operation of the selection button BTc, the setting managing unit 111 sets a stamping target on a per company basis. For example, the setting management unit 111 displays a screen on which company IDs or company names registered in the store management DB 141 are displayed as a list. The setting managing unit 111 sets, as a stamping target, a company ID of a company selected from the list.

The setting screen SCb includes a file selection button BTd. The file selection button BTd is an operation piece for reading setting information (hereinafter referred to as target setting file as well) in which a store ID, a brand ID, or a company ID set as a stamping target is set in advance.

Upon operation of the file selection button BTd, the setting managing unit 111 displays a screen for of selecting a target setting file stored in the center server 1 or the like and causing an operator to select a target setting file to be read. Upon reading the selected target setting file, the setting managing unit 111 automatically sets, based on content of the target setting file, a stamping target by store, brand, or company according to the target setting file.

The format of the target setting file does not particularly matter. Any format can be adopted. For example, the target setting file may be created in a CSV format in which the store ID, the brand ID, and the company ID are divided by commas as illustrated in FIG. 14.

FIG. 14 is a diagram illustrating an example of setting content of the target setting file. As illustrated in the figure, a target setting file STF includes items for a brand ID, a company ID, and a store ID. Stamping targets are described for each of rows by dividing the items with commas.

If the target setting file STF is read and selection button BTa is operated, the setting managing unit 111 extracts store IDs “S001” and “S002” described in a fifth row and a sixth row of the target setting file STF. The setting managing unit 111 sets the store IDs “S001” and “S002” as targets.

If the selection button BTb is operated, the setting managing unit 111 extracts brand IDs “B001” to “B004” described in a first row to the sixth row of the target setting file STF. The setting managing unit 111 sets the extracted brand IDs “B001” to “B004” as targets. The setting managing unit 111 may set, as a target, a store ID belonging to each of the brand IDs “B001” to “B004” registered in the store management DB 141.

If the selection button BTc is operated, the setting managing unit 111 extracts company IDs “C001” and “C002” described in the third row to the sixth row of the target setting file STF. The setting managing unit 111 sets the extracted company IDs “C001” and “C002” as targets. The setting managing unit 111 may set, as a target, a store ID belonging to each of the company IDs “C001” and “C002” registered in the store management DB 141.

The reading of the target setting file STF may be performed prior to the operation of the selection buttons BTa to BTc or may be performed after the operation of the selection buttons BTa to BTc.

The setting screen SCb includes a promotion setting button BTe and a determination button BTf. The promotion setting button BTe is for setting an implementation period and a scale factor of a promotion.

If the promotion setting button BTe is operated, the setting managing unit 111 displays an input screen for inputting an implementation period and a scale factor of a promotion and receives an input of an implementation period and a scale factor from the operator. For example, the setting managing unit 111 may display a calendar or the like and support the input of an implementation period.

The determination button BTf is for instructing decision of content set on the setting screen SCb. If the determination button BTf is operated, the setting managing unit 111 registers the store ID, the brand ID, or the company ID set as the target and the input implementation period and the input scale factor in the promotion management DB 143 in correlation with each other. Specifically, the setting managing unit 111 registers, anew, in the promotion management DB 143, a promotion record 1431 in which the store ID, the brand ID, or the company ID set as the target are set as an application target of the promotion and correlated with the input implementation period and the input scale factor.

In this way, the setting managing unit 111 provides to the operator an interface for selecting a target of the stamp service to be any one of the stores ST, a brand, or a company. Consequently, the operator who performs setting can easily and flexibly select the stores ST set as the target of the stamp service. Therefore, it is possible to achieve improvement in convenience.

In the above explanation, an example is explained in which the setting of the stamp service relating to the promotion is performed using the setting screen SCb. However, a target of setting is not limited to this. For example, a stamping condition may be set for a store, a brand, or a company using the same setting screen as the setting screen SCb.

On the setting screen SCb explained above, the operation piece corresponding to the store, the brand, and the company is displayed as the operation piece for selecting a target. However, in other examples, any two of these operation pieces may be displayed. Operation pieces may be provided for each of a brand name (a brand ID) and a company name (a company ID) on the setting screen SCb.

Referring back to FIG. 12, certain functional aspects of the center server 1 are explained. The acquiring unit 112 acquires, via the communication unit 17, electronic receipt data transmitted from the POS terminal 2. The acquiring unit 112 generates a new receipt record 1441 every time electronic receipt data is acquired and stores the new receipt record 1441 in the receipt DB 144.

The acquiring unit 112 analyzes the electronic receipt data and extracts a receipt ID, a transaction date and time, and a transaction amount included in the electronic receipt data. The acquiring unit 112 generates the receipt record 1441 with the member ID, the store ID, the receipt ID, the transaction date and time, the transaction amount, and the receipt data and stores the receipt record 1441 in the receipt DB 144. At this time, the acquiring unit 112 sets the stamp target flag of the receipt record 1441 to “0” and does not set the card type ID and the card ID.

The issuing unit 113 issues stamp data if the electronic receipt data acquired by the acquiring unit 112 satisfies an issuance condition for stamps (hereinafter referred to as stamping condition as well).

Specifically, every time a new receipt record 1441 is stored in the receipt DB 144, the issuing unit 113 determines, based on the store management DB 141 and the stamp card setting DB 142, whether a store ID included in the receipt record 1441 is a target of the stamp service. More specifically, the issuing unit 113 determines whether the store ID of the receipt record 1441 corresponds to a target of any card type ID set in the stamp card setting DB 142. If a brand ID or a company ID is set as a target of the stamp card setting DB 142, the issuing unit 113 refers to a store ID of a store belonging to the pertinent brand ID or company ID from the store management DB 141 to determine whether the store ID of the receipt record 1441 is a target.

If the store ID of the receipt record 1441 is not a target for any of the card type IDs, the issuing unit 113 determines that the stamping condition is not satisfied. In this case, the issuing unit 113 sets the stamp target flag of the receipt record 1441 to “0”.

If the store ID of the receipt record 1441 is a target of one of the card type IDs, the issuing unit 113 reads out a unit amount from the card record 1451 of the corresponding card type ID and determines whether a transaction amount included in the receipt record 1441 is equal to or more than the unit amount (transaction threshold).

If the transaction amount is less than the unit amount, the issuing unit 113 determines that the stamping condition is not satisfied. In this case, the issuing unit 113 sets the stamp target flag of the receipt record 1441 to “0”.

If the transaction amount is equal to or more than the unit amount, the issuing unit 113 determines that the stamping condition is satisfied. In this case, the issuing unit 113 divides the transaction amount by the unit amount to derive an integer, which is a quotient of the division, as the number of stamps to be granted. The issuing unit 113 sets the stamp target flag of the receipt record 1441 to “1”. The issuing unit 113 specifies a card ID from the card record 1451 of the stamp card DB 145 based on the member ID of the receipt record 1441 and the card type ID determined as the application target. The issuing unit 113 sets the card type ID and the card ID in the receipt record 1441.

Further, the issuing unit 113 determines whether the store ID and the transaction date and time included in the receipt record 1441 correspond to conditions of a target and an implementation period of any promotion record 1431 stored in the promotion management DB 143. If the store ID and the transaction date and time do not correspond to conditions of any promotion records 1431, the issuing unit 113 issues stamp data equivalent to the number of stamps calculated from the receipt record 1441. The stamp data includes the store ID, the receipt ID, and the like of the receipt record 1441.

If the store ID and the transaction date and time satisfy the conditions of a promotion record 1431, the issuing unit 113 multiplies the number of stamps calculated from the receipt record 1441 by a scale factor defined in the pertinent promotion record 1431 and sets a result of the multiplication as the number of stamps to be granted. The issuing unit 113 issues stamp data equivalent to the multiplied number of stamps.

The updating unit 114 adds the stamp data issued (granted) by the issuing unit 113 to stamp card data of the purchaser. Specifically, the updating unit 114 stores a stamp number and stamp data in correlation with each other in the card record 1451 of the stamp card DB 145 identified by the member ID, the card type ID, and the card ID included in the receipt record 1441. The updating unit 114 adds the number of stamp data (the number of stamps) issued by the issuing unit 113 to the number of collected stamps of the electronic stamp card. The updating unit 114 issues stamp numbers in ascending order.

The information providing unit 115 controls a receipt image based on the receipt data stored in the receipt DB 144 and an electronic stamp card image based on the card record 1451 stored in the stamp card DB 145 to be displayed on the information terminal 5 of the purchaser.

Specifically, upon receiving a receipt list request command from the information terminal 5, the information providing unit 115 extracts, based on a member ID included in the received request, the receipt record 1441 including the member ID from the receipt DB 144. The information providing unit 115 generates a receipt list image in which store IDs of the receipt records 1441 or store names identified from the store IDs, receipt IDs, and transaction date and times are listed. The information providing unit 115 transmits data of the generated receipt list image to the information terminal 5 at a list request command transmission source. Consequently, in the information terminal 5 that transmits the list request command, the receipt list image is displayed on the display unit 55.

The purchaser who checks the receipt list image touches and selects, out of the receipt list, a display row of a receipt on which the purchaser desires to check transaction details. If the display row of the receipt is touched, a receipt browsing request command is transmitted from the information terminal 5 to the center server 1. The browsing request command includes a store ID and a receipt ID of the selected receipt and a member ID stored in the information terminal 5.

If receiving a browsing request command from the information terminal 5, the information providing unit 115 reads out, from the receipt DB 144, receipt data requested to be browsed. Specifically, the information providing unit 115 searches through the receipt record 1441 coinciding with the member ID, the store ID, and the receipt ID included in the browsing request command and reads out the receipt data from the receipt record 1441.

Subsequently, the information providing unit 115 checks the stamp target flag of the receipt record 1441. If the stamp target flag is “1”, the information providing unit 115 adds image data of a “stamped” button to a receipt image explained below. If the stamp target flag is “0”, the information providing unit 115 does not add image data of the “stamped” button.

Subsequently, the information providing unit 115 generates, based on the receipt data requested to be browsed, for example, a receipt image representing the same receipt as a paper receipt. The information providing unit 115 transmits data of the generated receipt image to the information terminal 5 at a browsing request command transmission source. Consequently, on the information terminal 5 that sent the browsing request command, the receipt image is displayed on the display unit 55.

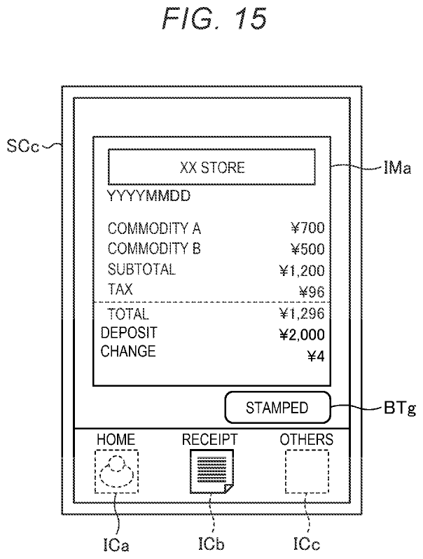

FIG. 15 is a diagram illustrating an example of the receipt image displayed on the display unit 55 of the information terminal 5. As illustrated in FIG. 15, a receipt image IMa corresponding to the receipt data is displayed on a screen SCc. In this example, since the receipt data satisfies the issuance condition for stamps, an image of a “stamped” button BTg is displayed on the screen SCa together with the receipt image IMa.

The purchaser can check an electronic stamp card in which stamps issued for the receipt data are collected. When checking the electronic stamp card, the purchaser can press the “stamped” button BTg. If the “stamped” button BTg is operated, a stamp request command is transmitted from the information terminal 5 to the center server 1. The stamp request command includes a store ID and a receipt ID of the receipt data and a member ID stored in the information terminal 5.

Upon receiving the stamp request command from the information terminal 5, the information providing unit 115 reads out, from the stamp card DB 145, the card record 1451 of the requested electronic stamp card. Specifically, the information providing unit 115 reads out a card type ID and a card ID from the receipt record 1441 coinciding with the member ID, the store ID, and the receipt ID included in the stamp request command. The information providing unit 115 searches through the stamp card DB 145 and detects the card record 1451 coinciding with the card type ID and the card ID read out from the receipt record 1441. The information providing unit 115 searches through the stamp card setting DB 142 and detects the card setting record 1421 of the card type ID read out from the receipt record 1441.

The information providing unit 115 generates an electronic stamp card image based on card image data of the detected card setting record 1421. The information providing unit 115 gives stamp images based on the card image data to the generated electronic stamp card image by the number of stamps collected in the card record 1451.

Specifically, the information providing unit 115 forms, in the electronic stamp card image, stamp frames for the maximum number of stamps specified by the card setting record 1421 and allocates a series of frame numbers to the stamp frames.

If stamp data is stored in an area of a stamp number “1” in the card record 1451, the information providing unit 115 displays, in correlation with the stamp data, in a first color, a stamp image in a stamp frame to which a frame number “1” is allocated. Subsequently, if stamp data is stored in an area of a stamp number “2” in the card record 1451, the information providing unit 115 displays, in correlation with the stamp data, a stamp image in a stamp frame to which a frame number “2” is allocated.

At this time, the information providing unit 115 determines whether a store ID and a receipt ID of the stamp data stored in the area of the stamp number “1” and a store ID and a receipt ID of the stamp data stored in the area of the stamp number “2” coincide. If the store IDs and the receipt IDs coincide, the information providing unit 115 displays, in the first color, the stamp image in the stamp frame to which the frame number “2” is allocated. If the store IDs and the receipt IDs do not coincide, the information providing unit 115 displays, in a second color, the stamp image in the stamp frame to which the frame number “2” is allocated. The second color is different from the first color. The information providing unit 115 executes the same processing for the subsequent stamp numbers to differentiate a display color for each of store IDs and receipt IDs. The display color may be differentiated for each of store IDs.

If the number of stamps (the number of collected stamps) collected in the card record 1451 exceeds the maximum number of stamps of the card setting record 1421, the information providing unit 115 generates electronic stamp card images equivalent to a number obtained by adding 1 to a quotient obtained by dividing the number of collected stamps by the maximum number of stamps. In this case, the information providing unit 115 allocates serial frame numbers to a plurality of electronic stamp card images and gives stamp data and stamp images of stamp numbers corresponding to the frame numbers to the electronic stamp card images.

After generating an electronic stamp card image to which the stamp data are given in this way, the information providing unit 115 transmits data of the generated electronic stamp card image to the information terminal 5 at a stamp request command transmission source. Consequently, in the information terminal 5 that transmits the stamp request command, the electronic stamp card image is displayed on the display unit 55.

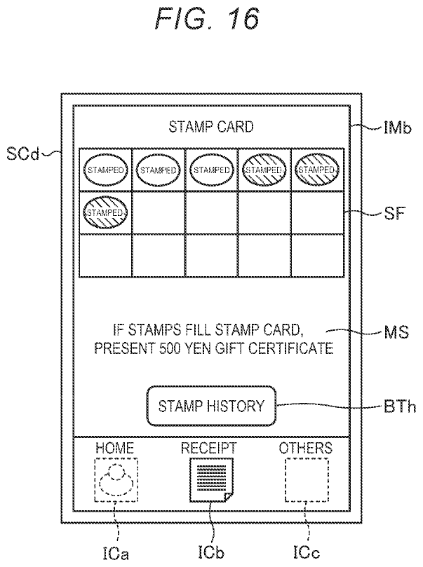

FIG. 16 is a diagram illustrating an example of the electronic stamp card image displayed on the display unit 55 of the information terminal 5. An example is illustrated in which, in a stamp card including fifteen stamp frames SF, an electronic stamp card image to which six stamp images in total are given is displayed on a screen SCd.

In the stamp frames SF, a frame number “1” is set on the upper left and a frame number “2” is set on the right of the frame number “1”. Stamp images in the first color are displayed in the stamp frames SF of frame numbers “1” to “3”, stamp images in the second color are displayed in the stamp frames SF of frame numbers “4” and “5”, and stamp images in the third color are displayed in the stamp frames SF of a frame number “6”. On the screen SCd, an image of a stamp history button BTh is also displayed together with an electronic stamp card image IMb. A message MS indicating a privilege obtained if stamps are collected to the maximum number of stamps is also displayed.

In FIG. 16, for convenience of explanation, a character “stamped” is displayed in a circular frame. A difference in a color is represented by presence of absence of hatching in the frame or the direction of the hatching. If a plurality of electronic stamp card images are present, the plurality of electronic stamp card images can be divided and displayed by, for example, swipe operation or the like for moving a screen in the left-right direction.

The purchaser who checks the electronic stamp card image can check a receipt, which is a purchase record of a transaction, for which any stamp was issued. The purchaser can also check a history of stamps issued to the electronic stamp card. For checking a receipt, the purchaser touches a stamp image of the receipt. For checking the history, the purchaser touches the stamp history button BTh.

If a stamp image is touched, a stamp selection command is transmitted from the information terminal 5 to the center server 1. The stamp selection command includes at least a member ID and a receipt ID of the stamp data associated with the touched stamp image. If the stamp history button BTh is touched, a stamp history request command is transmitted from the information terminal 5 to the center server 1. The stamp history request command includes information capable of specifying an electronic stamp card (the receipt record 1441) being browsed such as a member ID, a card type ID, and a card ID.

Upon receiving the stamp history request command from the information terminal 5, the information providing unit 115 generates a stamp history image based on the receipt record 1441 specified by the stamp history request command. Specifically, the information providing unit 115 acquires, in the order of stamp numbers of the receipt record 1441, a store ID and a receipt ID described in stamp data of the stamp numbers. Subsequently, the information providing unit 115 searches through the receipt DB 144 and detects the receipt record 1441 including the store ID and the receipt ID. The information providing unit 115 generates a stamp history image including, as a list, a transaction date and time of the receipt record 1441, a store name identified by the store ID, and the number of stamps. The number of stamps is the number of stamp data in which the same store ID and the receipt ID are continuously described in the order of the stamp numbers.

Subsequently, the information providing unit 115 transmits data of the generated stamp history image to the information terminal 5 at a history request command transmission source. Consequently, in the information terminal 5 that transmits the history request command, the stamp history image is displayed on the display unit 55.

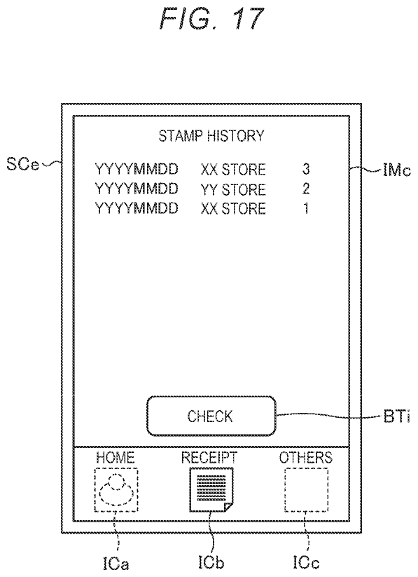

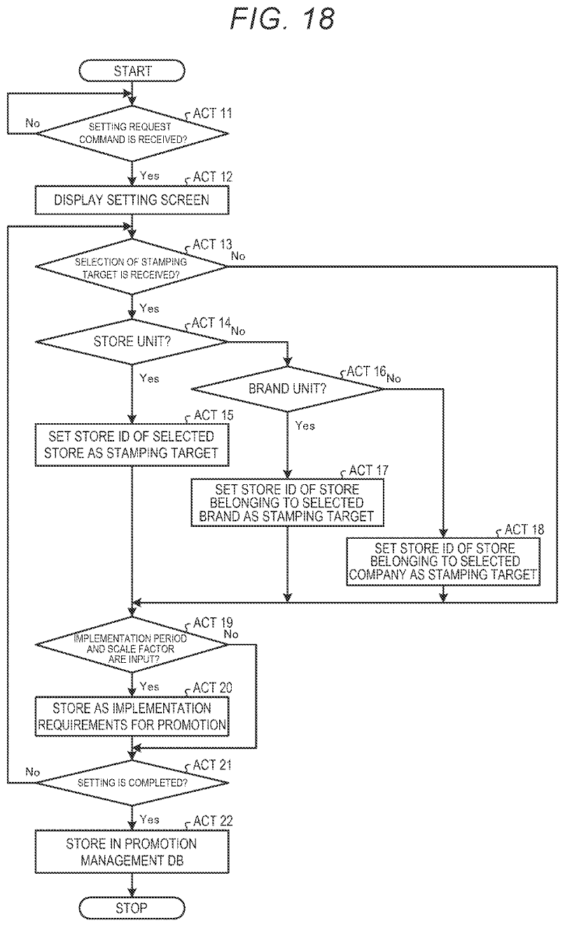

FIG. 17 is a diagram illustrating an example of the stamp history image displayed on the display unit 55 of the information terminal 5. A stamp history image IMc is displayed on a screen SCe. The stamp history image IMc indicates that, for example, three stamps are granted by shopping in an XX store, two stamps are granted by shopping in a YY store, and one stamp is granted by other shopping in the XX store. On the screen SCe, an image of a check button BTi is also displayed together with the stamp history image IMc. If the check button BTi is operated, the information terminal 5 erases the stamp history image IMc and displays the preceding screen SCd or screen SCc.

Upon receiving the stamp selection command from the information terminal 5, the information providing unit 115 searches through the receipt DB 144 and detects the receipt record 1441 including the member ID, the store ID, and the receipt ID instructed by the stamp selection command. Subsequently, the information providing unit 115 generates a receipt image based on receipt data included in the detected receipt record 1441. The information providing unit 115 transmits data of the generated receipt image to the information terminal 5 at a stamp selection command transmission source. Consequently, in the information terminal 5 that transmits the stamp selection command, a receipt image at the time when a selected stamp is issued is displayed.

According to control of the information providing unit 115 explained above, by using the information terminal 5, the purchaser can browse the receipt image IMa and can browse the electronic stamp card image IMb correlated with an electronic receipt of the receipt image IMa. The electronic stamp card correlated with the electronic receipt indicates an electronic stamp card on which stamps granted according to content of a transaction for which the electronic receipt is issued are collected. The purchaser can browse the electronic stamp card image IMb simply by touching the “stamped” button BTg displayed on the receipt image IMa. Therefore, it is possible to efficiently link the electronic receipt system and the electronic stamp card system.

In the following explanation, an operation example of the center server 1 explained above is explained.

First, an operation example relating to setting of a stamp service performed by the center server 1 is explained with reference to FIG. 18. FIG. 18 is a flowchart illustrating an example of stamp service setting processing performed by the center server 1. In this processing, setting processing for a stamp service involved in implementation of a promotion is explained.

First, the setting managing unit 111 stays on standby until a setting request command is received from the operation unit 16 or an external device (No in Act 11). Upon receiving the setting request command (Yes in Act 11), the setting managing unit 111 causes a display device of a device sending the setting request command request to display a setting screen for supporting setting (Act 12). For example, the setting managing unit 111 causes the display unit 15 to display the setting screen illustrated in FIG. 13.

Subsequently, the setting managing unit 111 determines whether operation for selecting the store ST or a store range (group) as a stamping target of stamps in the promotion is performed (Act 13).

If receiving selection of a store unit (Yes in Act 13 to Yes in Act 14), the setting managing unit 111 sets, as a stamping target, a store ID of a store selected based on the target setting file STF or the like (Act 15) and shifts to Act 19.

If receiving selection of a brand unit (Yes in Act 13 to No in Act 14 to Yes in Act 16), the setting managing unit 111 sets, as a stamping target, a brand ID of a brand selected based on the target setting file STF or the like (Act 17) and shifts to Act 19. In other words, the setting managing unit 111 sets store IDs belonging to the pertinent brand ID collectively as stamping targets according to the processing in Act 17.

If receiving selection of a company unit (Yes in Act 13 to No in Act 14 to No in Act 16), the setting managing unit 111 sets, as a stamping target, a company ID of a company selected based on the target setting file STF or the like (Act 18) and shifts to Act 19. In other words, the setting managing unit 111 sets store IDs belonging to the pertinent company ID collectively as stamping targets according to the processing in Act 18.

If an operation is not received in Act 13 (No in Act 13), the setting managing unit 111 shifts to Act 19.

Subsequently, the setting managing unit 111 determines whether an implementation period and a scale factor of the promotion are input (Act 19). If an implementation period and a scale factor are not input (No in Act 19), the setting managing unit 111 shifts to Act 21.

If detecting that an implementation period and a scale factor of the promotion are input (Yes in Act 19), the setting managing unit 111 stores the input implementation period and the input scale factor as implementation requirements for the promotion (Act 20) and shifts to Act 21.

Subsequently, the setting managing unit 111 determines whether operation for instructing setting completion is received (Act 21). If the operation for instructing setting completion is not received (No in Act 21), the setting managing unit 111 returns the processing to Act 13.

If the operation for instructing setting completion is received (Yes in Act 21), the setting managing unit 111 generates the promotion record 1431 in which the set stamping target and the input implementation period and the input scale factor are correlated and stores the promotion record 1431 in the promotion management DB 143 (Act 22).

At a point in time when the setting completion is instructed in Act 21, if the stamping target is not set and the implementation requirements are not input, the setting managing unit 111 may display a screen for informing that unset items are present and return the processing to Act 13.

According to the processing explained above, the center server 1 can set stores ST as a target of the stamp service by individual stores, brands, or operating company. Therefore, the center server 1 can improve convenience of an operator who selects the stamping targets.

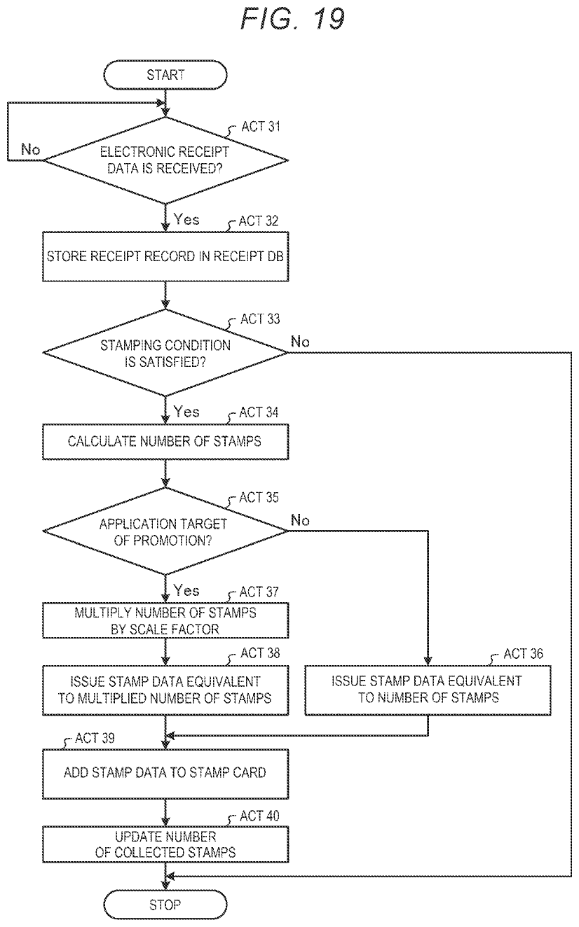

Subsequently, an operation example relating to acquisition of electronic receipt data performed by the center server 1 is explained. FIG. 19 is a flowchart illustrating an example of acquisition processing for electronic receipt data performed by the center server 1.

First, the acquiring unit 112 stays on standby until electronic receipt data is transmitted from any store ST (POS terminal 2) (No in Act 31). Upon receiving electronic receipt data from a POS terminal 2 (Yes in Act 31), the acquiring unit 112 generates a new receipt record 1441 from the electronic receipt data and stores the receipt record 1441 in the receipt DB 144 (Act 32).

Subsequently, the issuing unit 113 determines whether the receipt record 1441 stored in Act 32 satisfies the stamping condition (Act 33). If the receipt record 1441 does not satisfy the stamping condition (No in Act 33), the issuing unit 113 ends the processing.

If the receipt record 1441 satisfies the stamping condition (Yes in Act 33), the issuing unit 113 divides a transaction amount by a unit amount to calculate the number of stamps that is a quotient of the division (Act 34). If determining that the receipt record 1441 satisfies the stamping condition, the issuing unit 113 specifies the card record 1451, that is, a card type and a card ID to which stamps are added.

Subsequently, the issuing unit 113 determines whether the receipt record 1441 stored in Act 32 is an application target of the promotion (Act 35). If determining that the receipt record 1441 is not the application target of the promotion (No in Act 35), the issuing unit 113 issues stamp data equivalent to the number of stamps derived in Act 34 (Act 36) and shifts to Act 39.

If determining that the receipt record 1441 is the application target of the promotion (Yes in Act 35), the issuing unit 113 multiplies the number of stamps derived in Act 34 by a scale factor of the relevant promotion (Act 37). Subsequently, the issuing unit 113 issues stamp data equivalent to the multiplied number of stamps (Act 38) and shifts to Act 39.

Subsequently, the updating unit 114 adds the stamp data issued by the issuing unit 113 to the relevant electronic stamp card (the card record 1451) (Act 39). The updating unit 114 adds the added number of stamps to the number of collected stamps to update the acquired number of stamps (Act 40).

According to the processing explained above, if purchase performed in the store ST satisfies the stamping condition, the center server 1 imparts the stamps (the number of which corresponds to a purchase amount) to an electronic stamp card of a card type corresponding to the store ST. If the purchase performed in the store ST corresponds to an application condition for a promotion, the center server 1 multiplies the number of stamps by a scale factor corresponding to the promotion and imparts the number of stamps of a result of the multiplication.

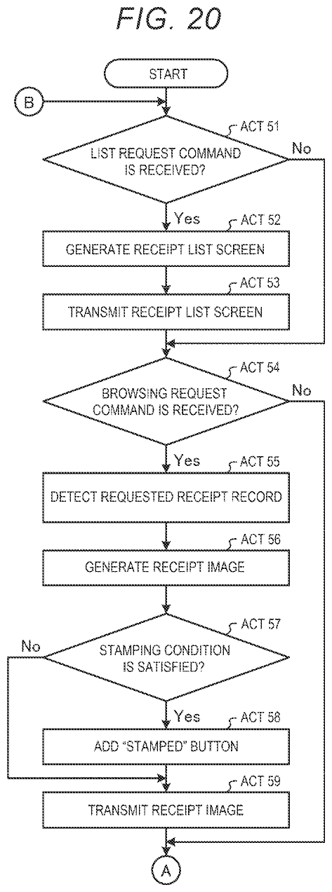

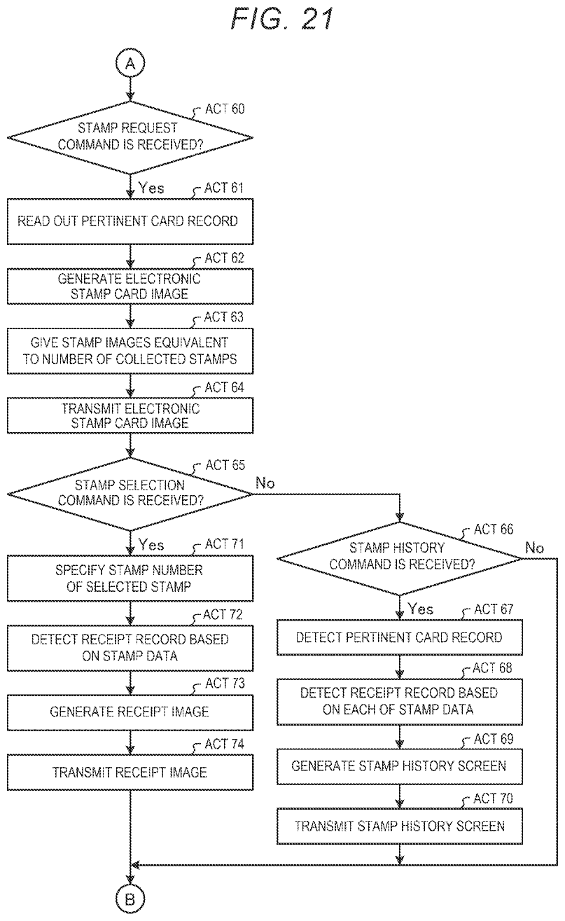

Subsequently, an operation relating to browsing of electronic receipt data and an electronic stamp card performed by the center server 1 is explained with reference to FIGS. 20 and 21. FIGS. 20 and 21 are flowcharts illustrating an example of browsing processing performed by the center server 1.

First, the information providing unit 115 determines whether a list request command is received from the information terminal 5 (Act 51). If the list request command is not received (No in Act 51), the information providing unit 115 shifts to Act 54.

If the list request command is received (Yes in Act 51), the information providing unit 115 generates a receipt list image based on the receipt record 1441 relating to a purchaser at a transmission source stored in the receipt DB 144 (Act 52). Subsequently, the information providing unit 115 transmits data of the generated receipt list image to the information terminal 5 at a transmission source (Act 53). Consequently, in the information terminal 5 that transmits the list request command, a receipt list image is displayed on the display unit 55.

Subsequently, the information providing unit 115 determines whether a browsing request command is received (Act 54). If the browsing request command is not received (No in Act 54), the information providing unit 115 shifts to Act 60.

If the browsing request command is received (Yes in Act 54), the information providing unit 115 detects the receipt record 1441 for which a browsing request is received from the receipt DB 144 (Act 55). Subsequently, the information providing unit 115 generates a receipt image based on receipt data included in the receipt record 1441 (Act 56).

The information providing unit 115 determines, based on the stamp target flag of the receipt record 1441, whether the stamping condition is satisfied (Act 57). If the stamping condition is not satisfied (No in Act 57), that is, the stamp target flag is “0”, the information providing unit 115 shifts to Act 59. If the stamping condition is satisfied (Yes in Act 57), that is, the stamp target flag is “1”, the information providing unit 115 adds a “stamped” button to the receipt image (Act 58) and shifts to Act 59.

Subsequently, the information providing unit 115 transmits data of the generated receipt image to the information terminal 5 at a browsing request command transmission source (Act 59). Consequently, in the information terminal 5 that transmits the browsing request command, the receipt image is displayed on the display unit 55.

Subsequently, the information providing unit 115 determines whether a stamp request command is received from the information terminal 5 (Act 60). If the stamp request command is not received (No in Act 60), the information providing unit 115 shifts to Act 65.

If the stamp request command is received (Yes in Act 60), the information providing unit 115 reads out, from the stamp card DB 145, the card record 1451 specified based on the stamp request command (Act 61).

Subsequently, the information providing unit 115 generates an electronic stamp card image based on card image data corresponding to a card type ID of the card record 1451 (Act 62). Subsequently, the information providing unit 115 gives a stamp image equivalent to the number of stamps collected in the card record 1451 to the generated electronic stamp card image (Act 63). Subsequently, the information providing unit 115 transmits data of the electronic stamp card image given to the stamp image to the information terminal 5 at a stamp request command transmission source (Act 64). Consequently, in the information terminal 5 that transmits the stamp request command, the electronic stamp card image is displayed on the display unit 55.

Subsequently, the information providing unit 115 determines whether a stamp selection command is received from the information terminal 5 (Act 65). If the stamp selection command is not received (No in Act 65), the information providing unit 115 determines whether a stamp history request command is received (Act 66). If the stamp history request command is not received (No in Act 66), the information providing unit 115 returns to Act 51 and stays on standby until any browsing request command is received.

If the stamp history command is received (Yes in Act 66), the information providing unit 115 detects, from the stamp card DB 145, the card record 1451 designated by the stamp history command (Act 67). Subsequently, the information providing unit 115 detects, from the receipt DB 144, the receipt record 1441 corresponding to each of stamp data included in the detected card record 1451 (Act 68).

Subsequently, the information providing unit 115 generates a stamp history image based on the stamp data and the receipt record 1441 (Act 69). The information providing unit 115 transmits data of the generated stamp history image to the information terminal 5 at a history request command transmission source (Act 70). Consequently, in the information terminal 5 that transmits the history request command, the stamp history image is displayed on the display unit 55.

If the stamp selection command is received (Yes in Act 65), the information providing unit 115 specifies a stamp number of a stamp instructed by the stamp selection command (Act 71). Subsequently, the information providing unit 115 detects, based on stamp data of the specified stamp number, from the receipt DB 144, the receipt record 1441 corresponding to a store ID and a receipt ID described in the stamp data (Act 72).

Subsequently, the information providing unit 115 generates a receipt image from the detected receipt record 1441 (Act 73). The information providing unit 115 transmits data of the generated receipt image to the information terminal 5 at a stamp selection command transmission source (Act 74). Consequently, in the information terminal 5 that transmits the stamp selection command, a receipt image at the time when a selected stamp is issued is displayed on the display unit 55.

According to the processing explained above, the center server 1 can provide an electronic receipt image, an electronic stamp card image correlated with the electronic receipt image, and the like to the information terminal 5 (the purchaser) that accesses the center server 1.

As explained above, the center server 1 acquires receipt data from the POS terminal 2, determines whether the receipt data satisfies the stamping condition and issues stamp data if the receipt data satisfies the stamping condition. The center server 1 updates data (the card record 1451) of a stamp card for collecting stamp data, the data being stored in correlation with the purchaser, to be a result of collecting the issued stamp data. The center server 1 includes the setting managing unit 111 that sets, as an element of the stamping condition, the store ST where purchase is performed. The setting managing unit 111 sets the store ST that is a target of the setting among a plurality of stores ST using any one setting unit among a store unit for individually designating the store ST, a brand unit indicating a store group to which a business form is common, and a company unit indicating a store group to which an operation company is common.

Consequently, the center server 1 can perform setting relating to a stamp card service in any unit among the store unit, the brand unit, and the company unit. Therefore, it is possible to more flexibly perform the stamp card service in, for example, a company that expands a wide range of businesses.

### (Modification 1)

In an embodiment explained above, the electronic stamp card system is integrated into an electronic receipt system as one example. However, in other examples, the electronic stamp card system may be configured as a standalone electronic stamp card system rather than as part of an electronic receipt system. In this case, the center server 1 does not need to store electronic receipt data transmitted from the POS terminal 2 but may rather just use such data for determining whether a stamping condition has been satisfied. In this case, the center server 1 may acquire, from the POS terminal 2, data that correlates receipt data and a member ID and a store ID or receipt data including a member ID or a store ID instead of full electronic receipt data.

The programs executed in the devices explained above can be incorporated in the ROMs, the storage units, or the like in advance. The programs may be recorded in a non-transitory, computer-readable recording medium such as a CD-ROM, a flexible disk (FD), a CD-R, or a DVD (Digital Versatile Disk) as a file of an installable format or an executable format. The programs may be stored on a computer connected to a network such as the Internet and provided by being downloaded through the network. The programs may be provided or distributed through a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A server device for a retail stamp card service, the server device comprising:
a communication interface connectable to a network;
a storage unit for storing electronic stamp cards for a plurality of purchasers and stamp issuance conditions for a plurality of stores; and
a processor configured to:
acquire purchaser identification information and receipt data indicating details of a purchase by a purchaser at a store;
determine, based on the receipt data, whether a stamp issuance condition has been satisfied;
issue stamp data if the stamp issuance condition has been satisfied;
update stamp card data associated with the purchaser identification information according to the issued stamp data; and
set stamp issuance conditions for stores in the plurality of stores on an individual store basis, a brand basis, and an operating company basis based on operator input to the server device.

2. The server device according to claim 1, wherein the processor is further configured to cause a screen for receiving settings for stamp conditions for stores in the plurality of stores on the individual store basis, the brand basis, and the operating company basis to be displayed.

3. The server device according to claim 2, further comprising:
a display screen, wherein
the screen is displayed on the display screen.

4. The server device according to claim 1, wherein each store in the plurality of stores is associated with a store ID, a company ID, and a brand ID in the storage unit.

5. The server device according to claim 1, wherein the processor is further configured to provide an image of a stamp card for the purchaser to an information terminal of the purchaser via the communication interface.

6. The server device according to claim 5, wherein the image of the stamp card includes images of stamps corresponding to the issued stamp data associated with the purchaser identification information of the purchaser.

7. The server device according to claim 1, wherein the processor is further configured to:
determine, based on the receipt data, whether a promotional event condition has been satisfied and adjust the stamp data if the promotional event condition has been satisfied.

8. A server device for an electronic receipt service, the server device comprising:
a communication interface connectable to a network;
a storage unit with a first database for storing electronic stamp cards for a plurality of purchasers, a second database for stamp issuance conditions for a plurality of stores, and a third database storing electronic receipts for the plurality of purchasers; and
a processor configured to:
acquire purchaser identification information and receipt data indicating details of a purchase by a purchaser at a store;
determine, based on the receipt data, whether a stamp issuance condition has been satisfied;
issue stamp data if the stamp issuance condition has been satisfied;
update stamp card data associated with the purchaser identification information according to the issued stamp data;
set stamp issuance conditions for stores in the plurality of stores on an individual store basis, a brand basis, and an operating company basis based on operator input to the server device; and
provide an electronic receipt image corresponding to receipt data of the purchaser upon request of the purchaser.

9. The server device according to claim 8, wherein the processor is further configured to cause a screen for receiving settings for stamp conditions for stores in the plurality of stores on the individual store basis, the brand basis, and the operating company basis to be displayed.

10. The server device according to claim 9, further comprising:
a display screen, wherein
the screen is displayed on the display screen.

11. The server device according to claim 8, wherein each store in the plurality of stores is associated with a store ID, a company ID, and a brand ID in the storage unit.

12. The server device according to claim 8, wherein the processor is further configured to provide an image of a stamp card for the purchaser to an information terminal of the purchaser via the communication interface.

13. The server device according to claim 12, wherein the image of the stamp card includes images of stamps corresponding to the issued stamp data associated with the purchaser identification information of the purchaser.

14. The server device according to claim 8, wherein the processor is further configured to:
determine, based on the receipt data, whether a promotional event condition has been satisfied and adjust the stamp data if the promotional event condition has been satisfied.

15. A non-transitory, computer-readable medium storing program instructions which when executed by a server device of a retail stamp card service causes the server device to perform a method comprising:
acquiring purchaser identification information and receipt data indicating details of a purchase by a purchaser at a store;
determining, based on the receipt data, whether a stamp issuance condition has been satisfied;
issuing stamp data if the stamp issuance condition has been satisfied;
updating stamp card data associated with the purchaser identification information according to the issued stamp data; and
setting stamp issuance conditions for stores in the plurality of stores on an individual store basis, a brand basis, and an operating company basis based on operator input to the server device.

16. The non-transitory, computer-readable medium according to claim 15, the method further comprising:
causing a screen for receiving settings for stamp conditions for stores in the plurality of stores on the individual store basis, the brand basis, and the operating company basis to be displayed.

17. The non-transitory, computer-readable medium according to claim 16, wherein the screen is displayed on a display screen of the server device.

18. The non-transitory, computer-readable medium according to claim 15, the method further comprising:
providing an image of a stamp card for the purchaser to an information terminal of the purchaser via a communication interface.

19. The non-transitory, computer-readable medium according to claim 18, wherein the image of the stamp card includes images of stamps corresponding to the issued stamp data associated with the purchaser identification information of the purchaser.

20. The non-transitory, computer-readable medium according to claim 15, the method further comprising:
determining, based on the receipt data, whether a promotional event condition has been satisfied and adjusting the stamp data if the promotional event condition has been satisfied.
